(19) United States
(12) Patent Application Publication
(10) Pub. No.: US 2025/0279442 A1
(43) Pub. Date: Sep. 4, 2025

(54) END CELL HEATER FOR FUEL CELL

(71) Applicant: Hanon Systems, Daejeon (KR)

(72) Inventors: Kil Sang JANG, Daejeon (KR); Yong Ha CHAE, Daejeon (KR)

(73) Assignee: Hanon Systems, Daejeon (KR)

(21) Appl. No.: 19/061,898

(22) Filed: Feb. 24, 2025

(30) Foreign Application Priority Data
Mar. 4, 2024 (KR) 10-2024-0030503

(51) Int. Cl. H01M 8/0267

(52) U.S. Cl. CPC H01M 8/0267

(57) ABSTRACT

Disclosed is an end cell heater for a fuel cell, including a heater plate; a power supply terminal coupled to the heater plate; a first electrode terminal coupled to a first end of the terminal; a heating element stacked on the heater plate; and a second electrode terminal coupled to the heating element and coupled corresponding to the first electrode terminal, wherein the heater plate includes a terminal guide protruding to surround the first electrode terminal, thereby ensuring electric connection between the first electrode terminal and the second electrode terminal.

### CROSS REFERENCE TO RELATED APPLICATION

The present application claims priority to Korean Patent Application No. 10-2024-0030503, filed Mar. 4, 2024, the entire contents of which are incorporated herein for all purposes by this reference.

### BACKGROUND OF THE INVENTION

### Field of the Invention

The disclosure relates to an end cell heater for a fuel cell, and more particularly to an end cell heater for a fuel cell, in which electrical connection is ensured at a portion where a heating element of the end cell heater and a terminal are electrically connected.

### Description of the Related Art

In general, a fuel cell refers to a power generation device that converts chemical energy into electrical energy through the oxidation and reduction of hydrogen, and is in the spotlight as the next-generation alternative energy source because the fuel cell discharges only water as a by-product, produces little NOₓ, SOₓ and dust, reduces carbon dioxide emissions, and makes almost no noise unlike other existing chemical energy sources.

The fuel cell includes a unit cell that is basically divided into an electrolyte plate containing an electrolyte, a fuel electrode (anode), an air electrode (cathode), and a separator plate separating them. However, the unit cell typically generates a low voltage of 0.6 V to 0.8 V, and thus dozens or hundreds of unit cells 30 are stacked to constitute a fuel cell stack 1 as shown in FIG. 1 and obtain a desired electrical output.

In such a fuel cell configured as the stack, water produced by combination between oxygen and hydrogen remains in the unit cell (end cell) located on the outermost side in a direction where the unit cells are stacked, and an end cell heater for heating the end cell is provided to prevent water from freezing inside the end cell due to cold external temperature in winter. Further, the end cell uses coolant for cooling because reaction heat is generated therein.

The end cell heater employs a snap terminal to couple and electrically connect a heating element to a terminal, in which a female snap terminal on the heating element side and a male snap terminal on the terminal side are fitted to each other and assembled into the snap terminal.

However, during or after the assembly, the female snap terminal may be separated due to a positional error between the female snap terminal and the male snap terminal. In this case, even though a fastening force is applied from the outside, the electrical connection of the snap terminal may not be achieved. In other words, when the female snap terminal and the male snap terminal are assembled or disassembled, the female snap terminal on the terminal side may break away from the terminal in a state of being coupled to the male snap terminal on the heating element side, and the female snap terminal may climb a plastic skin. In this case, a problem arises in that the electric connection is not made even though the fastening force applied from the outside is increased.

### DOCUMENTS OF RELATED ART

(Patent Document 1) KR 10-2261535 B1 (Jun. 1, 2021)

### SUMMARY OF THE INVENTION

The disclosure has been conceived to solve problems as described above, and an aspect of the disclosure is to provide an end cell heater for a fuel cell, in which electrical connection is ensured at a portion to which electrode terminals for electrically connecting a heating element of the end cell heater and a terminal are coupled.

According to an embodiment of the disclosure, an end cell heater for a fuel cell includes: a heater plate formed with a terminal accommodating groove; a power supply terminal coupled to the heater plate and including a first end disposed adjacent to the terminal accommodating groove; a first electrode terminal provided inside the terminal accommodating groove and coupled and electrically connected to the first end of the terminal; a heating element stacked on a first surface of the heater plate in a thickness direction; and a second electrode terminal coupled to the heating element, and coupled corresponding to the first electrode terminal, wherein the heater plate includes a terminal guide formed to protrude from the bottom of the terminal accommodating groove and shaped to surrounding the first electrode terminal.

Further, the terminal guide may be disposed to be spaced radially outward from the first electrode terminal.

Further, the terminal guide may be formed with a slope on a radially inward side thereof, and the slope may radially outward incline toward a protruding direction of the terminal guide.

Further, the terminal guide may be formed as a ring to surround an entire periphery of the first electrode terminal.

Further, the first electrode terminal may be a female snap terminal, and the second electrode terminal may be a male snap terminal inserted in and coupled to the female snap terminal.

Further, the first electrode terminal and the power supply terminal may be coupled by a rivet.

Further, the first electrode terminal may include a cup portion coupled to the power supply terminal and a plurality of elastic protrusions formed above the cup portion, and the second electrode terminal may be inserted and coupled inside the plurality of elastic protrusions of the first electrode terminal.

Further, a lower end of the second electrode terminal may be disposed higher than an upper end of the cup portion of the first electrode terminal.

Further, an upper end of the plurality of elastic protrusions of the first electrode terminal may be disposed to be spaced apart from an upper end of the second electrode terminal and a lower surface of the heating element.

Further, an upper end of the terminal guide may be disposed lower in height than the plurality of elastic protrusions of the first electrode terminal.

Further, the plurality of elastic protrusions of the first electrode terminal may protrude more outward than the cup portion in a radial direction.

Further, the end cell heater may further include a current collecting plate stacked on a first surface of the heating element in the thickness direction, being in surface-contact with the heating element, and coupled to the heater plate.

Further, the end cell heater may further include an end plate stacked on a second surface of the heater plate in the thickness direction, coupled to the heater plate, and formed with an air channel through which air flows and a fuel channel through which fuel flows. Further, the first end of the power supply terminal may be

exposed to an inside of the terminal accommodating groove, and the first electrode terminal may be coupled and electrically connected to the first end of the power supply terminal exposed to the inside of the terminal accommodating groove.

Further, the plurality of elastic protrusions may be spaced apart from each other along an upper end of the cup portion in a circumferential direction.

Further, the plurality of elastic protrusions may be formed to bend radially outward at the upper end of the cup portion, extend upward, make a U-turn radially inward, and extend downward, and a free end of the elastic protrusion may be spaced upward apart from the upper end of the cup portion

Further, the end cell heater may further include a guide member coupled to the heating element and surrounding an outer side of the second electrode terminal; and a sealing member inserted in an inner circumference of the terminal accommodating groove and surrounding an outer side of the first electrode terminal, wherein the guide member is inserted in the terminal accommodating groove, and the sealing member is radially interposed between the terminal accommodating groove and the guide member.

Further, the end cell heater may further include a sealing pad interposed between the heater plate and the heating element.

### BRIEF DESCRIPTION OF THE DRAWINGS

FIG. 1 is a perspective view of a conventional fuel cell.

FIG. 2 is an assembled perspective view of an end cell heater for a fuel cell according to an embodiment of the disclosure.

FIG. 3 is an assembled cross-sectional view showing a cross-section of an end cell heater for a fuel cell according to an embodiment of the disclosure cut in a widthwise direction.

FIGS. 4 and 5 are exploded and assembled cross-sectional views showing cross-sections of an end cell heater for a fuel cell according to an embodiment of the disclosure cut in a lengthwise direction.

FIG. 6 is a perspective view of a first electrode terminal and a terminal guide of an end cell heater for a fuel cell according to an embodiment of the disclosure.

FIGS. 7 and 8 are exploded and assembled perspective views showing a fuel cell with an end cell heater for a fuel cell according to an embodiment of the disclosure.

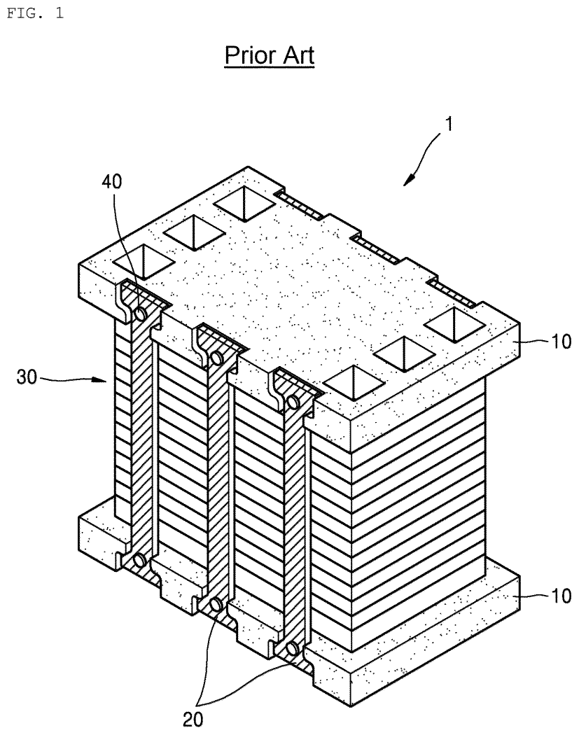

### DETAILED DESCRIPTION OF THE INVENTION

Hereinafter, an end cell heater for a fuel cell with the foregoing configuration according to the disclosure will be described in detail with reference to the accompanying drawings.

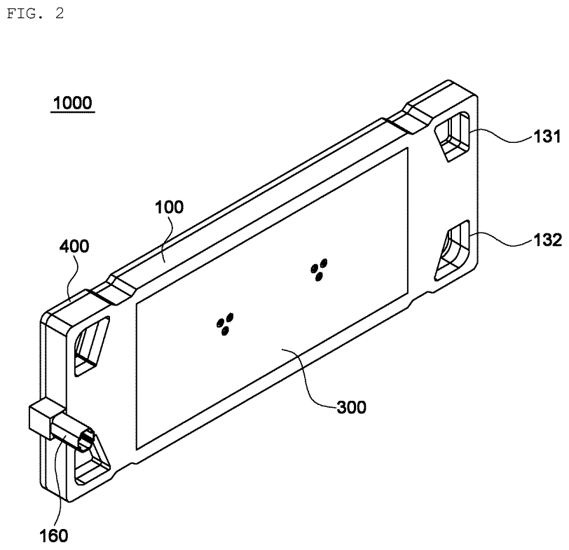

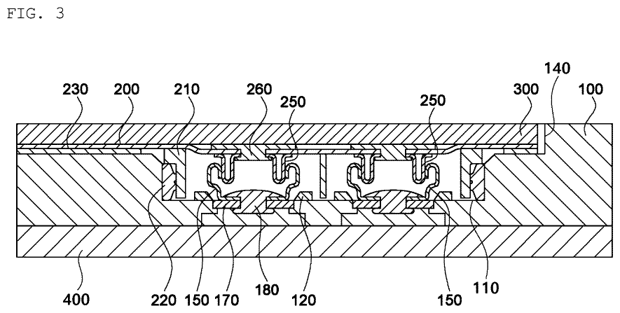

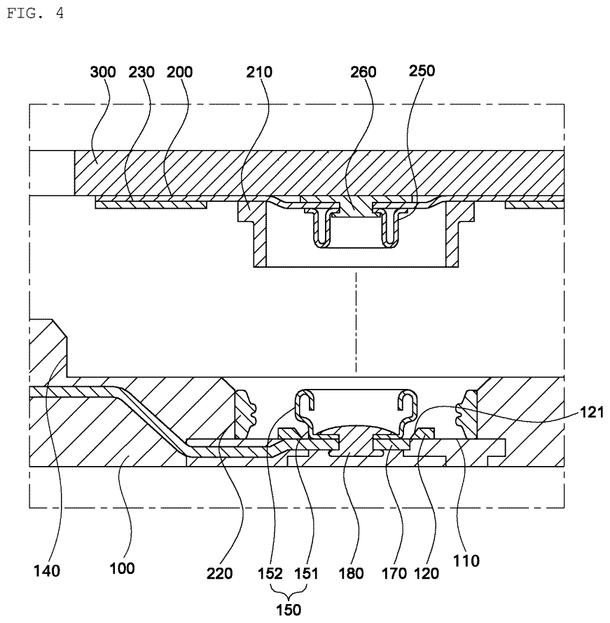

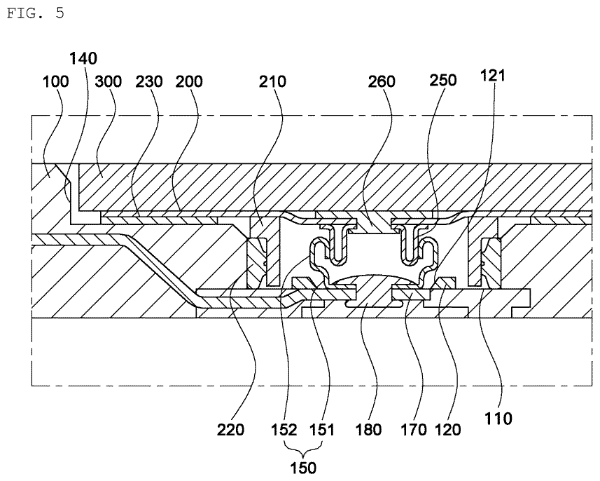

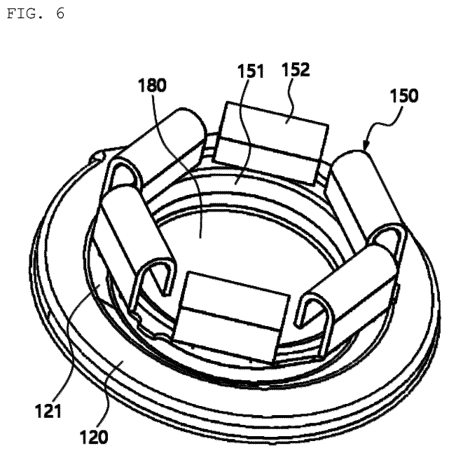

FIG. 2 is an assembled perspective view of an end cell heater for a fuel cell according to an embodiment of the disclosure, FIG. 3 is an assembled cross-sectional view showing a cross-section of an end cell heater for a fuel cell according to an embodiment of the disclosure cut in a widthwise direction, FIGS. 4 and 5 are exploded and assembled cross-sectional views showing cross-sections of an end cell heater for a fuel cell according to an embodiment of the disclosure cut in a lengthwise direction, and FIG. 6 is a perspective view of a first electrode terminal and a terminal guide of an end cell heater for a fuel cell according to an embodiment of the disclosure.

As shown therein, an end cell heater 1000 for a fuel cell according to an embodiment of the disclosure may include a heater plate 100, a power supply terminal 170, a first electrode terminal 150, a heating element 200, a second electrode terminal 250, and a terminal guide 120.

The heater plate 100 serves as a housing to which the heating element 200 is mounted, and may be made of an electrically insulating plastic material. The heater plate 100 may be roughly shaped like a rectangular plate, and formed with a mounting groove 140 recessed downward on one surface in a thickness direction so that the heating element 200 may be inserted in the mounting groove 140. In an area of the heater plate 100, where the mounting groove 140 is formed, a terminal accommodating groove 110 may be recessed downward from the mounting groove 140. In addition, the heater plate 100 may be formed integrally with a connector 160. Further, the heater plate 100 may be formed with an air flow path 131 and a fuel flow path 132 penetrating the heater plate 100 in the thickness direction on opposite sides of the heater plate 100 in a lengthwise direction. Although not shown, a coolant flow path may be formed penetrating the heater plate 100 in the thickness direction on both sides of the heater plate 100 in the lengthwise direction.

The power supply terminal 170 may be coupled to the heater plate 100. Additionally, the power supply terminal 170 may have a first end adjacent to the terminal accommodating groove 110, and a second end coupled to the connector 160. For example, the power supply terminal 170 may be formed integrally with the heater plate 100 and the connector 160 by insert injection, and may be coupled in various other ways. Further, the first end of the power supply terminal 170 may be exposed to the inside of the terminal accommodating groove 110.

The first electrode terminal 150 is provided inside the terminal accommodating groove 110, so that the first electrode terminal 150 can be coupled and electrically connected to the first end of the power supply terminal 170 exposed to the inside of the terminal accommodating groove 110. For example, the first electrode terminal 150 and the power supply terminal 170 may be coupled to each other by a rivet 180. The first electrode terminal 150 may be made of metal and be provided as a pair.

The heating element 200 may generate heat by receiving electricity, and may for example be a film heater shaped like a thin plate. The heating element 200 may be stacked on one surface of the heater plate 100 in the thickness direction, and the heating element 200 may be inserted in the mounting groove 140 of the heater plate 100.

The second electrode terminal 250 may be provided as a pair, and the second electrode terminal 250 may be coupled and electrically connected to the heating element 200 by a holding member 260. In addition, the second electrode terminal 250 may be positioned corresponding to the first electrode terminal 150, and the second electrode terminal 250 may be shaped corresponding to the first electrode terminal 150 and coupled to the first electrode terminal 150. For example, the first electrode terminal 150 may be a female snap terminal, and the second electrode terminal 250 may be a male snap terminal inserted in and coupled to the female snap terminal. Therefore, the second electrode terminal 250 and the first electrode terminal 150 may be fitted together and elastically coupled to each other, and thus firmly joined without easily breaking away in an opposite direction to a press-fitting direction after the second electrode terminal 250 is coupled to the first electrode terminal 150.

The terminal guide 120 may be formed integrally with the heater plate 100, and the terminal guide 120 may protrude upward from the bottom of the terminal accommodating groove 110 in the form of surrounding the first electrode terminal 150. For example, the terminal guide 120 may be provided in the form of a ring surrounding the entire periphery of the first electrode terminal 150, and the terminal guide 120 may be spaced radially outward from the first electrode terminal 150. In addition, the terminal guide 120 may be formed with a slope 121 on a radially inward side thereof, and the slope 121 may be formed to incline radially outward from the bottom of the terminal accommodating groove 110 in an upward protruding direction of the terminal guide 120.

Therefore, the end cell heater for the fuel cell according to the disclosure has an advantage that electric connection is ensured between the heating element and the terminal because the first electrode terminal is guided to come into contact with the terminal by the terminal guide when a fastening force is applied in a direction, where the heater plate and the heating element are stacked, even though the first electrode terminal is separated from the terminal in the state that the first electrode terminal on the terminal side is coupled to the second electrode terminal on the heating element side while the heating element and the heater plate are assembled or disassembled.

Further, the first electrode terminal 150 may include a cup portion 151 and a plurality of elastic protrusions 152. The cup portion 151 may be shaped like a cup and coupled to the power supply terminal 170. The plurality of elastic protrusions 152 may be formed above the cup portion 151, and the plurality of elastic protrusions 152 may be spaced apart from each other along the upper end of the cup portion 151 in a circumferential direction. In addition, the second electrode terminal 250 may be inserted and coupled inside the plurality of elastic protrusions 152 while being surrounded by the plurality of elastic protrusions 152. Further, the lower end of the second electrode terminal 250 may be disposed higher than the upper end of the cup portion 151 of the first electrode terminal 150. Therefore, even though there is a positional error between the first electrode terminal 150 and the second electrode terminal 250, the plurality of elastic protrusions 152 makes the second electrode terminal 250 be easily coupled to the first electrode terminal 150.

Further, the upper end of the plurality of elastic protrusions 152 of the first electrode terminal 150 may be disposed to be spaced apart from the upper end of the second electrode terminal 250 and the lower surface of the heating element 200. Accordingly, the plurality of elastic protrusions 152 may be easily elastically deformed.

Further, the upper end of the terminal guide 120 may be disposed lower in height than the plurality of elastic protrusions 152 of the first electrode terminal 150. Therefore, even though the second electrode terminal 250 is inserted inside the plurality of elastic protrusions 152 and the plurality of elastic protrusions 152 are deformed to spread outward in the radial direction, there may be not interference between the elastic protrusions 152 and the terminal guide 120.

Further, the outer surface of the plurality of elastic protrusions 152 of the first electrode terminal 150 may be formed to protrude more outward than the cup portion 151 in the radial direction. For example, the plurality of elastic protrusions 152 are each formed to bend radially outward at the upper end of the cup portion 151, extend upward, make a U-turn radially inward, and extend downward. Additionally, the free end of the elastic protrusion may be located above the upper end of the cup portion, and the free ends of the elastic protrusions may be arranged to be spaced upward apart from the upper end of the cup portion. Accordingly, the plurality of elastic protrusions 152 is more easily elastically deformed to sufficiently absorb the positional error between the first electrode terminal 150 and the second electrode terminal 250.

Further, the end cell heater for the fuel cell according to the disclosure may further include a guide member 210, a sealing member 220, a sealing pad 230, a current collecting plate 300, and an end plate 400.

The guide member 210 may be coupled to the heating element 200. For example, the guide member 210 may be coupled and fixed to the heating element 200. The guide member 210 may be formed to surround the entire outer side of the pair of second electrode terminals 250, and the guide member 210 may be partially inserted in the terminal accommodating groove 110 of the heater plate 100. Further, the sealing member 220 may be made of an elastic material, and the sealing member 220 may be inserted in the inner circumference of the terminal accommodating groove 110. In addition, the sealing member 220 may be formed to entirely surround the outer side of the pair of first electrode terminals 150. Therefore, the sealing member 220 is compressed between the lateral wall of the terminal accommodating groove 110 and the guide member 210, thereby sealing a space between the terminal accommodating groove 110 and the guide member 210. In this case, the position of the second electrode terminal 250 is guided by the guide member 210, so that the first electrode terminal 150 and the second electrode terminal 250 can be coupled to each other in a correct position. Further, the sealing pad 230 may be formed on the surface of the heating element 200 facing the heater plate 100, and the sealing pad 230 may be attached to or formed integrally with the heating element 200. Therefore, a space between the heating element 200 and the heater plate 100 may be sealed by the sealing pad 230.

Further, the end cell heater for the fuel cell according to the disclosure may further include a current collecting plate 300 stacked on one surface of the heating element 200 in the thickness direction, being in surface-contact with the heating element 200, and coupled to the heater plate 100. The current collecting plate 300 refers to a part that collects and transmits electricity generated from a fuel cell stack, and may be formed of an electrically conductive material, i.e., a metal plate. In addition, a pair of current collecting terminals 310 may be formed to protrude from the current collecting plate 300. For example, through holes may be formed penetrating the heater plate 100 and the heating element 200 in the thickness direction positions corresponding to the current collecting terminals 310, and the current collecting plate 300 may be stacked on one surface of the heating element 200 in the thickness direction and be inserted in the mounting groove 140 formed on the heater plate 100. In this case, the current collecting terminal 310 passes through the through holes formed in the heater plate 100 and the heating element 200, and the free end of the current collecting terminal 310 protrude from the other surface of the heater plate 100 in the thickness direction. Thus, the current collecting plate 300 is coupled to the heater plate 100, thereby bring the heating element 200 into close contact with the heater plate 100.

Further, the end cell heater for the fuel cell according to an embodiment of the disclosure may further include the end plate 400 stacked on the other surface of the heater plate 100 in the thickness direction. The end plate 400 may be formed with the air channel through which air flows and the fuel channel through which fuel flows, and an air flow path connected to the air channel and a fuel flow path connected to the fuel channel may be formed.

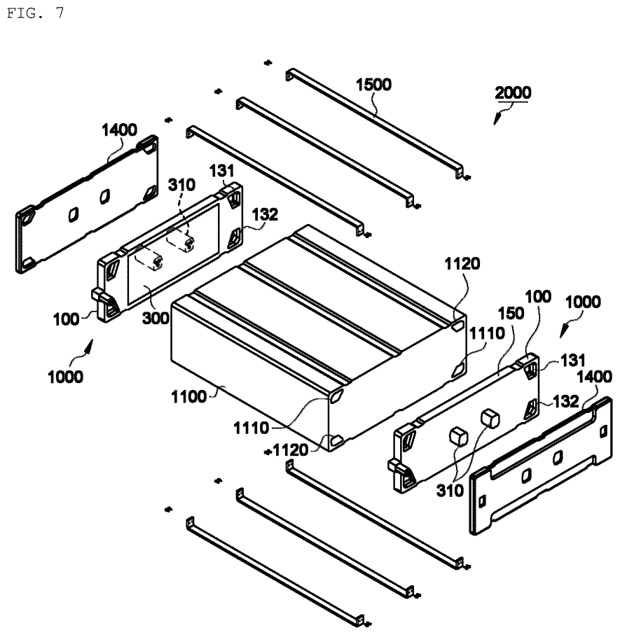

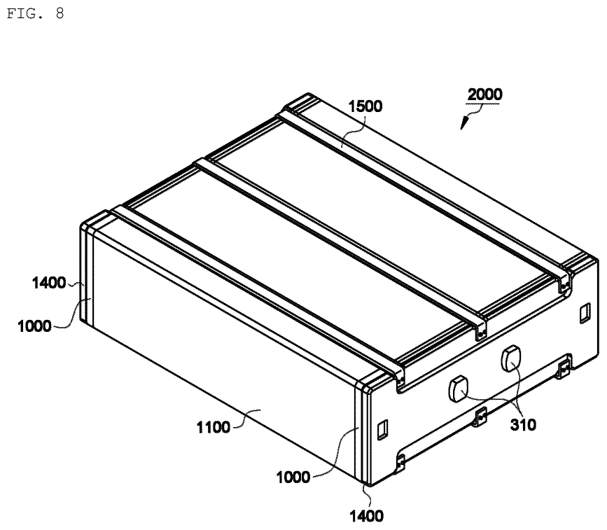

FIGS. 7 and 8 are exploded and assembled perspective views showing a fuel cell with an end cell heater for a fuel cell according to an embodiment of the disclosure.

As shown therein, a fuel cell 2000 according to the disclosure may include a fuel cell stack 1100 formed by stacking unit cells and having an air flow path 1110 and a fuel flow path 1120 formed on opposite sides and penetrating in a stacking direction; and an end cell heater 1000 coupled to the fuel cell stack 1100, stacked on the outer side of the outermost unit cell among the unit cells, and connecting with the flow paths.

In other words, the fuel cell 2000 may be formed by stacking the end cell heater 1000 on the fuel cell stack 1100 formed by stacking reaction cells, and the end cell heater 1000 may be stacked on and in close contact with the outermost stacked reaction cells in the same stacking direction. In this case, the air flow path 1110 and the fuel flow path 1120 formed in the fuel cell stack 1100 may be connected corresponding to the air flow path 131 and the fuel flow path 132 of the end cell heater 1000. In this case, the fuel cell stack 1100 may include a cooling flow path formed between the air flow path 1110 and the fuel flow path 1120 and allowing a heat exchange medium (refrigerant) to pass through the unit cells, thereby cooling the unit cells.

Therefore, the end cell heater is installed in the fuel cell stack as the end cell heater is just stacked on and brought into close contact with the outer side of the outermost reaction cell in the same way that the unit cells are stacked to make up the fuel cell stack, and the structure for connecting the flow paths is so simple that the installation of the end cell heater can be very easy. In this way, the end cell heater is used to prevent water from freezing inside the end cell of the fuel cell stack, thereby improving the fuel cell's initial startability and initial driving performance.

Further, there may be additionally provided electrically insulating covers 1400 stacked on the outer side where the end cell heater 1000 is stacked, and formed to expose the current collecting terminal 310 of the end cell heater 1000 to the outside. Further, there may be additionally provided fastening members 1500, both ends of which are coupled to the covers 1400. In other words, the insulating covers 1400 are placed on the outer sides of the two end cell heaters 1000, which are respectively arranged to be stacked on both sides of the fuel cell stack 1100 in the thickness direction, in the thickness direction, and the fastening members 1500 are used to maintain the two covers 1400, the two end cell heaters 1000, and the fuel cell stack 1100 pressed in the stacking direction.

As described above, the end cell heater for the fuel cell according to the disclosure has an advantage that electric connection is ensured between the electrode terminals because the first electrode terminal is guided to come into contact with the terminal by the terminal guide when a fastening force is applied from the outside in the stacking direction, even though the first electrode terminal is separated from the terminal in the state that the first electrode terminal on the terminal side is coupled to the second electrode terminal on the heating element side while the heating element and the heater plate are assembled or disassembled.

The disclosure is not limited to the aforementioned embodiments, is applicable variously, and is variously modifiable by a person having ordinary knowledge in the art to which the disclosure pertains without departing from the scope of the disclosure as defined in the appended claims.

DESCRIPTION OF REFERENCE NUMERALS

| | |
|---|---|
| 1000: end cell heater for fuel cell | |
| 100: heater plate | |
| 110: terminal accommodating groove | |
| 120: terminal guide | 121: slope |
| 131: air channel | 132: fuel channel |
| 140: mounting groove | |
| 150: first electrode terminal | |
| 151: cup portion | 152: elastic protrusion |
| 160: connector | 170: power supply terminal |
| 180: rivet | 200: heating element |
| 210: guide member | 220: sealing member |
| 230: sealing pad | 250: second electrode terminal |
| 260: holding member | 300: current collecting plate |
| 310: current collecting terminal | |
| 400: end plate | 1100: fuel cell stack |
| 1110: air channel | 1120: fuel channel |
| 1400: cover | 1500: fastening member |
| 2000: fuel cell | |

What is claimed is:

1. An end cell heater for a fuel cell comprising:
a heater plate formed with a terminal accommodating groove;
a power supply terminal coupled to the heater plate and comprising a first end disposed adjacent to the terminal accommodating groove;
a first electrode terminal provided inside the terminal accommodating groove and coupled and electrically connected to the first end of the power supply terminal;
a heating element stacked on a first surface of the heater plate in a thickness direction; and
a second electrode terminal coupled to the heating element, and coupled corresponding to the first electrode terminal, wherein
the heater plate comprises a terminal guide formed to protrude from the bottom of the terminal accommodating groove and shaped to surrounding the first electrode terminal.

2. The end cell heater of claim 1, wherein the terminal guide is disposed to be spaced radially outward from the first electrode terminal.

3. The end cell heater of claim 1, wherein the terminal guide is formed with a slope on a radially inward side thereof, and the slope radially outward inclines toward a protruding direction of the terminal guide.

4. The end cell heater of claim 1, wherein the terminal guide is formed as a ring to surround an entire periphery of the first electrode terminal.

5. The end cell heater of claim 1, wherein the first electrode terminal comprises a female snap terminal, and the second electrode terminal comprises a male snap terminal inserted in and coupled to the female snap terminal.

6. The end cell heater of claim 5, wherein the first electrode terminal and the power supply terminal are coupled by a rivet.

7. The end cell heater of claim 5, wherein
the first electrode terminal comprises a cup portion coupled to the power supply terminal and a plurality of elastic protrusions formed above the cup portion, and
the second electrode terminal is inserted and coupled inside the plurality of elastic protrusions of the first electrode terminal.

8. The end cell heater of claim 7, wherein a lower end of the second electrode terminal is disposed higher than an upper end of the cup portion of the first electrode terminal.

9. The end cell heater of claim 7, wherein an upper end of the plurality of elastic protrusions of the first electrode terminal is disposed to be spaced apart from an upper end of the second electrode terminal and a lower surface of the heating element.

10. The end cell heater of claim 7, wherein an upper end of the terminal guide is disposed lower in height than the plurality of elastic protrusions of the first electrode terminal.

11. The end cell heater of claim 7, wherein the plurality of elastic protrusions of the first electrode terminal protrudes more outward than the cup portion in a radial direction.

12. The end cell heater of claim 1, further comprising a current collecting plate stacked on a first surface of the heating element in the thickness direction, being in surface-contact with the heating element, and coupled to the heater plate.

13. The end cell heater of claim 1, further comprising an end plate stacked on a second surface of the heater plate in the thickness direction, coupled to the heater plate, and formed with an air channel through which air flows and a fuel channel through which fuel flows.

14. The end cell heater of claim 1, wherein
the first end of the power supply terminal is exposed to an inside of the terminal accommodating groove, and
the first electrode terminal is coupled and electrically connected to the first end of the power supply terminal exposed to the inside of the terminal accommodating groove.

15. The end cell heater of claim 7, wherein the plurality of elastic protrusions are spaced apart from each other along an upper end of the cup portion in a circumferential direction.

16. The end cell heater of claim 15, wherein
the plurality of elastic protrusions are formed to bend radially outward at the upper end of the cup portion, extend upward, make a U-turn radially inward, and extend downward, and
a free end of the elastic protrusion is spaced upward apart from the upper end of the cup portion.

17. The end cell heater of claim 1, further comprising:
a guide member coupled to the heating element and surrounding an outer side of the second electrode terminal; and
a sealing member inserted in an inner circumference of the terminal accommodating groove and surrounding an outer side of the first electrode terminal, wherein
the guide member is inserted in the terminal accommodating groove, and the sealing member is radially interposed between the terminal accommodating groove and the guide member.

18. The end cell heater of claim 1, further comprising a sealing pad interposed between the heater plate and the heating element.
